(19) United States
(12) Patent Application Publication
(10) Pub. No.: US 2011/0095731 A1
(43) Pub. Date: Apr. 28, 2011

(54) POWER FACTOR CORRECTION CONTROLLER, CONTROLLING METHOD THEREOF, AND ELECTRIC POWER CONVERTER USING THE SAME

(75) Inventors: Qing-Lin Zhao, Nanjing (CN); Ming-Zhu Li, Nanjing (CN); Zhi-Hong Ye, Nanjing (CN); Xue-Feng Tang, Nanjing (CN); Xin Guo, Nanjing (CN); Yu-Li Feng, Nanjing (CN)

(73) Assignees: SILITEK ELECTRONIC (GUANGZHOU) CO., LTD., Guangzhou (CN); LITE-ON TECHNOLOGY CORPORATION, Taipei City (TW)

(21) Appl. No.: 12/730,155

(22) Filed: Mar. 23, 2010

(30) Foreign Application Priority Data
Oct. 22, 2009 (CN) 200910193346.7

(51) Int. Cl. G05F 1/70

(52) U.S. Cl. 323/205

(57) ABSTRACT

A power factor correction controller is utilized for a power factor correction circuit in a critical conduction mode of an electric power converter. The power factor correction controller generates a control voltage according to an output voltage outputted from the electric power converter, and utilizes a first threshold value to detect the control voltage. The power factor correction controller can control the power factor correction circuit to operate in different modes according to various levels of a load. Therefore, an objective according to the present invention for reducing electric power consumption of the electric power converter in a light load or a no-load mode and improving energy transmission efficiency can be attained.

### BACKGROUND OF THE INVENTION

1. Field of the Invention

The present invention relates to a power factor correction controller, and in particular, to a power factor correction controller, a controlling method, and an electric power converter using the same in a critical conduction mode configured to improve light load efficiency and reduce electric power consumption under a light load or a no-load condition.

2. Description of Related Art

Most of electrical appliance products work with a direct current (DC) voltage, so the alternate current (AC) power supplied by the utility power network must be converted into DC power. The most common method is to use a diode bridge rectifier circuit and a filtering capacitor. This method is widely used because of the simple structure and low cost thereof. However, due to impedance characteristics of the filtering capacitor and the electrical appliance itself, a phase difference is generated between the input voltage and the input current. This leads to a decrease in the power factor and consequently leads to electric power consumption, and exacerbates pollution to the power supply network. To effectively solve this problem, a solution currently adopted is to design a power factor correction circuit at the downstream of the rectifier circuit so as to reduce the reactive component, improve the power factor and reduce the harmonic pollution to the power supply network.

Circuit topologies utilizing a power factor correction circuit to improve the power factor generally fall into the following categories: for example, the boost type, the buck type, and the buck-boost type. Depending on the current control principle adopted, the operation modes of power factor correction circuits may be further divided into the continuous current mode (CCM), the discontinuous current mode (DCM) and the critical conduction mode (CRM).

Generally speaking, the boosting action is the core technology for power factor correction. For a circuit of the boost type adopted commercially, reference may be made to FIG. 1, which is a schematic circuit diagram of an electric power converter having a boost type power factor correction circuit according to the prior art. As shown, the electric power converter 9 comprises a filter 91 (such as an EMI filter), a bridge rectifier 92 and a power factor correction circuit 93. The conventional technology illustrated herein is to, through design of a power factor correction controller 931, allow the power factor correction circuit 93 of the previous stage to work under the critical conduction mode. Herein, by use of the power factor correction controller 931, the power factor correction circuit 93 actively controls switching of a transistor Q to indirectly control the current waveform and the output voltage Vout, and then the output voltage Vout is converted by the DC/DC converter (not shown) of the next stage to supply necessary electric power to a load (not shown). This can effectively eliminate power consumption incurred by reverse recovery of the diode D, thereby improving efficiency of the electric power converter 9.

However, in the critical conduction mode, as the load decreases gradually, the switching frequency at which the power factor correction controller 931 controls the transistor Q increases, resulting in increased electric power consumption of the electric power converter 9. Besides, near a zero-crossing point of the AC voltage, the input voltage Vin of the power factor correction circuit 93 also become smaller to cause a higher switching frequency of the transistor Q. This also results in considerable loss due to less power transmission, thereby decreasing the efficiency of the electric power converter 9. At present, in order to reduce the power consumption of the power factor correction circuit 93 under a light load condition and no-load condition, a frequency skipping control mode is usually adopted.

Now, the frequency skipping control mode will be generally described with reference to the schematic circuitry in the power factor correction controller 931. The power factor correction controller 931 mainly comprises a regulator P1, a comparator P2 and a pulse width modulation circuit PWM. The regulator P1 has an input terminal thereof connected to a feedback signal pin FB to receive the output voltage Vout, and is configured to regulate the output voltage Vout to output a control voltage Vcon for reflecting an actual value of the load. The comparator P2 is configured to receive the control voltage Vcon and compare it with a setting voltage Vset. Finally, the pulse width modulation circuit PWM is configured to, according to the comparison result of the comparator P2 and a zero-crossing detection signal detected by a zero-crossing detection pin ZCD, output a drive signal at a drive signal pin Drive for controlling operations of the transistor Q, thereby accomplishing the objective of controlling the frequency skipping operation of the power factor correction circuit 93.

Referring to FIG. 2 and FIG. 2A for more detailed descriptions, waveform diagrams illustrating the frequency skipping control of the electric power converter having a boost type power factor correction circuit in certain aspects of the prior art are shown therein. FIG. 2A shows an enlarged view of a portion A of FIG. 2, which is intended to depict variations in the waveform of a current (iL) flowing through an inductor L.

First, when the load becomes lighter, the output voltage Vout increases, and accordingly the control voltage Vcon drops. Once the control voltage Vcon drops below the setting voltage Vset, the power factor correction circuit 93 controlled by the power factor correction controller 931 will stop the operation (off time) for decreasing the output voltage Vout. In turn, as the output voltage Vout declines, the control voltage Vcon increases. When the control voltage Vcon is larger than the setting voltage Vset, the power factor correction circuit 93 controlled by the power factor correction controller 931 will resume the operation (on time) for boosting the output voltage Vout. In turn, as the output voltage Vout increases, the control voltage Vcon drops. This process proceeds repeatedly to allow the critical conduction mode power factor correction circuit 93 to reduce electric power consumption under a light load or a no-load condition effectively through the frequency skipping operation.

Unfortunately, as the requirements on the light load efficiency and the no-load power consumption of the power supply become heightened increasingly, it becomes difficult for the frequency skipping controlling method described above to satisfy requirements of various international standards, e.g., standards relevant to energy saving established by Environmental Protection Agency (EPA) and Energy Star. Moreover, the frequency skipping operation of the conventional power factor correction circuit 93 in the critical conduction mode under a light load condition causes large variations of the output voltage Vout, which is unfavorable for optimization of the light load efficiency associated with the DC/DC converter of the next stage and also unfavorable for improvement of the overall light load efficiency.

### SUMMARY OF THE INVENTION

In view of the aforementioned issues, an objective of the present invention is to make improvement for the power factor correction circuit in the critical conduction mode, so that the power factor correction circuit can be controlled to operate in different specific modes according to different values of the load, thereby reducing the power consumption of the electric power converter at a light load or a no-load condition and improving the energy transmission efficiency. Thus, the output voltage will experience less variation, which is favorable for optimization of the light load efficiency associated with the DC/DC converter of the next stage.

To achieve the above-mentioned objective, in an aspect of the present invention, a power factor correction controller adapted for a power factor correction circuit of an electric power converter in a critical conduction mode is provided, which comprises a voltage regulation unit, a signal generation unit, a first comparator and a drive unit. The voltage regulation unit is configured to receive an output voltage of the electric power converter to generate a control voltage; the signal generation circuit is configured to generate a clock signal and, by use of a first threshold value that is preset, detect the control voltage to generate an bias voltage according to a level of the control voltage; the first comparator is configured to compare the bias voltage with an input voltage of the electric power converter to generate a triggering signal; and the drive unit is electrically connected to the voltage regulation unit, the signal generation circuit and the first comparator, and is configured to control a transistor of the power factor correction circuit. When the control voltage is lower than the first threshold value, the drive unit will control the transistor to operate in a standby mode according to the triggering signal and the clock signal.

To achieve the above-mentioned objective, in another aspect of the present invention, a control method for a power factor correction controller is provided. The power factor correction controller is adapted for a power factor correction circuit of an electric power converter in a critical conduction mode. The control method comprises the following steps of: firstly, an output voltage of the electric power converter is converted into a control voltage. Then, a clock signal is generated and the control voltage is detected by use of a first threshold value to generate a bias voltage according to a level of the control voltage, and next, a comparison is made between the bias voltage and an input voltage of the electric power converter to generate a trigger signal. Finally, a drive unit is provided to control a transistor of the power factor correction circuit, so that when the control voltage is lower than the first threshold value, the drive unit controls the transistor to operate in a standby mode according to the triggering signal and the clock signal.

To achieve the above-mentioned objective, in yet another aspect of the present invention, an electric power converter is provided, which comprises a filtering unit, a rectifier, a filtering capacitor and a power factor correction circuit. The power factor correction circuit further comprises therein the power factor correction controller described in the above aspects. Thereby, through control operations of the power factor correction controller, power consumption of the electric power converter at a light load or a no-load condition is reduced, and the energy transmission efficiency of the electric power converter itself is improved.

The above description as well as the following description and the attached drawings are all provided to further illustrate techniques and means that the present invention takes for achieving the prescribed objectives as well as effects of the present invention. Other objectives and advantages of the present invention will be described in the following descriptions and the attached drawings.

### BRIEF DESCRIPTION OF THE DRAWINGS

FIG. 1 is a schematic circuit diagram of an electric power converter having a boost type power factor correction circuit according to the prior art;

FIGS. 2 and 2A are waveform diagrams illustrating the frequency skipping control of the electric power converter having a boost type power factor correction circuit according to the prior art;

FIG. 3 is a block diagram of an embodiment of an electric power converter having a boost type power factor correction circuit according to the present invention;

FIG. 4 is a schematic circuit diagram of a first embodiment of the power factor correction controller according to the present invention; and

FIG. 5 is a schematic view of the operation modes versus the load value and switching frequency of the power factor correction circuit according to the present invention;

FIG. 6 is a schematic circuit diagram of a second embodiment of the power factor correction controller according to the present invention; and

FIG. 7 is a schematic view of the operation modes versus the load value and switching frequency of the power factor correction circuit according to the second embodiment of the present invention;

FIG. 8-1 and FIG. 8-2 are a flowchart of an embodiment of a control method for the power factor correction controller according to the present invention; and

FIG. 9 is a waveform diagram of an embodiment of the power factor correction circuit according to the present invention in a standby mode.

### DETAILED DESCRIPTION OF THE PREFERRED EMBODIMENTS

The present invention relates to an improved power factor correction circuit in a critical conduction mode, which is capable of operating in different specific modes according to different values of a load so as to reduce the power consumption of an electric power converter at a light load or a no-load condition and improve the energy transmission efficiency of the electric power converter. The power factor correction circuit of the present invention is applicable to circuit configurations of the boost type, the buck type and the boost-buck type without any limitation. For convenience of description, the following embodiments are all illustrated by a boost type circuit configuration commonly used in power factor correction circuits at present.

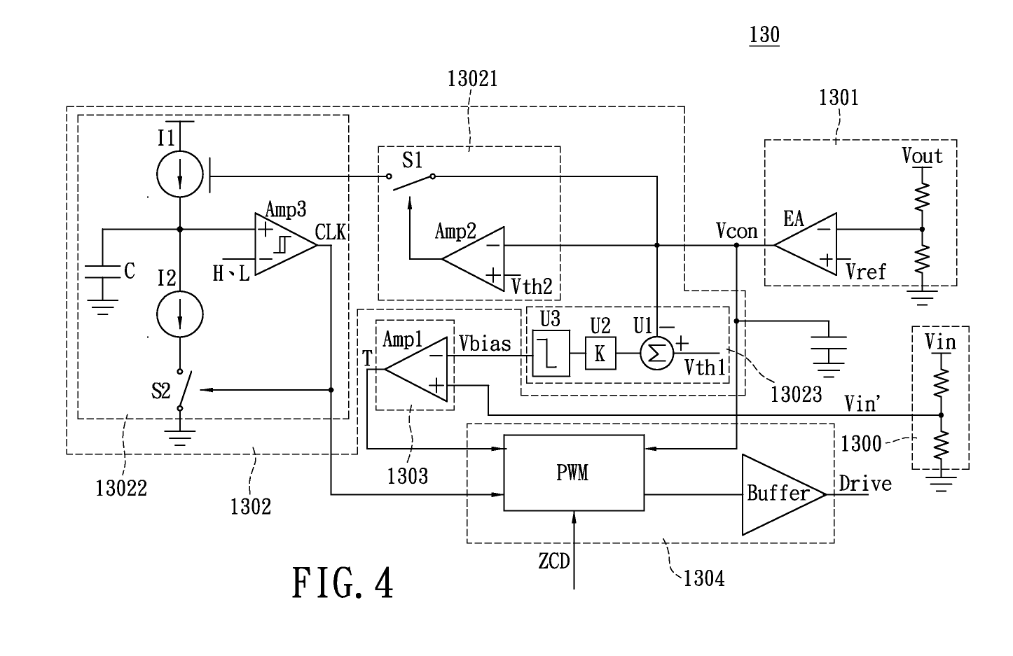

First, a description will be made on design of a circuit structure. Referring to FIG. 3, there is shown a block diagram of an embodiment of an electric power converter having a boost type power factor correction circuit according to the present invention. As shown, an electric power converter 1 of this embodiment comprises a filtering unit 11, a rectifier 12, a power factor correction circuit 13 and a filtering capacitor Cin. The filtering unit 11 is electrically connected to an AC power supply AC, and is configured to filter out high-frequency noises from an AC voltage of the AC power supply AC. The rectifier 12 is electrically connected to the filtering unit 11, and is configured to rectify the AC voltage to generate an input voltage Vin. The filtering capacitor Cin is connected in parallel to the rectifier 12, and is configured to further filter out noises from the input voltage Vin.

The power factor correction circuit 13 is designed into a critical conduction mode, and comprises an inductor L, a transistor Q, a diode D, an output capacitor Cout and a power factor correction controller 130. The operating principle of the boost type circuit formed by the inductor L, the transistor Q, the diode D and the output capacitor Cout will be readily understood by those of ordinary skill in the art, and thus will not be further described herein.

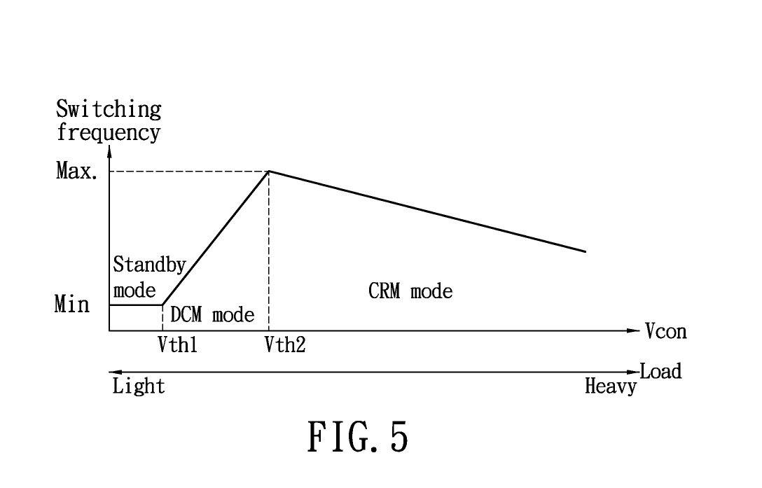

To describe design of the power factor correction controller 130 in detail, reference is made to FIG. 4 together, which is a schematic circuit diagram of a first embodiment of the power factor correction controller according to the present invention. The power factor correction controller 130 further comprises a sampling circuit 1300, a voltage regulation unit 1301, a signal generation circuit 1302, a first comparator 1303 (Amp1) and a drive unit 1304. In order to comply with requirements of the input specification of the first comparator 1303, the sampling circuit 1300 is designed to be electrically connected to the rectifier 12 so as to receive the sinusoidal input voltage Vin and regulate the input voltage Vin into an input voltage Vin′ of a certain level for supplying to the first comparator 1303. As shown in FIG. 4, the sampling circuit 1300 may be, for example, designed as a voltage dividing circuit schematic.

As shown in FIG. 4, the voltage regulation unit 1301 comprises, for example, an error amplifier EA. An negative input terminal of the error amplifier EA is electrically connected to an output terminal of the electric power converter 1 to receive an output voltage Vout, and a positive input terminal of the error amplifier EA is set to a reference voltage Vref, so that the error amplifier EA can amplify the output voltage Vout according to the reference voltage Vref to generate a control voltage Vcon for subsequent comparison purpose. In addition, if a load (not shown) connected to the output terminal of the electric power converter 1 becomes larger, the output voltage Vout will go lower and, accordingly, the control voltage Vcon will go higher; conversely, if the load becomes lighter, the output voltage Vout will go higher and, accordingly, the control voltage Vcon will go lower. In other words, the control voltage Vcon is directly proportional to a value of the load.

The signal generation circuit 1302 is electrically connected to the voltage regulation unit 1301, and in this embodiment, the signal generation circuit 1302 has a first threshold value Vth1 and a second threshold value Vth2 preset for voltage detection, in which the second threshold value Vth2 is greater than the first threshold value Vth1. Thus, the control voltage Vcon can be detected according to the first threshold value Vth1 and the second threshold value Vth2, so that a clock signal CLK and an bias voltage Vbias are generated respectively depending on a level of the control voltage Vcon.

More particularly, as shown in FIG. 4, the signal generation circuit 1302 further comprises a switch circuit 13021, a clock generation circuit 13022 and a bias calculation circuit 13023. The switch circuit 13021 includes, for example, a first switch S1 and a second comparator Amp2 in terms of the circuit structure. The first switch S1 has one terminal thereof electrically connected to an output terminal of the error amplifier EA of the voltage regulation unit 1301. An positive input terminal of the second comparator Amp2 is set to the second threshold value Vth2, and a negative input terminal of the second comparator Amp2 is electrically connected to the output terminal of the error amplifier EA, so that the second comparator Amp2 can control the first switch S1 to be turned on or off according to a comparison between the second threshold value Vth2 and the control voltage Vcon. Specifically, if the control voltage Vcon is greater than or equal to the second threshold value Vth2, the second comparator Amp2 will control the first switch 51 to be turned off; otherwise, if the control voltage Vcon is lower than the second threshold value Vth2, the second comparator Amp2 will control the first switch 51 to be turned on.

In practical design, the clock generation circuit 13022 may be, for example, a voltage controlled oscillator (VCO). As shown in FIG. 4, the circuit schematic of the clock generation circuit 13022 comprises a first current source I1, a second current source I2, a second switch S2, a capacitor C and a third comparator Amp3. The first current source I1 is designed as a controllable current source, and has a control terminal thereof electrically connected to the other terminal of the first switch 51 that is different from the terminal to which the error amplifier EA is connected. Thus, when the first switch 51 is turned on, a current output can be regulated proportionally to a level of the control voltage Vcon. The second current source I2 is connected in series with the first current source I1, and is designed to provide a current twice as that of the first current source I1.

The second switch S2 has one terminal thereof connected in series with the second current source I2, and has the other terminal thereof connected to the ground. The capacitor C has one terminal thereof electrically connected to a connecting junction of the first current source I1 and the second current source I2, and has the other terminal thereof connected to the ground. Thus, through charging and discharging of the capacitor C, an oscillating effect is produced to generate an oscillating voltage. Then, according to the oscillating voltage, the third comparator Amp3 further generates the clock signal CLK. It shall be further noted that, a positive input terminal of the third comparator Amp3 is electrically connected to a connecting junction of the first current source I1 the second current source I2 and the capacitor C, and a negative input terminal of the third comparator Amp3 is set to a high threshold value H and a low threshold value L. Thus, when finding through comparison that the oscillating voltage has reached the high threshold value H, the third comparator Amp3 controls the second switch S2 to turn on, so that the capacitor C is discharged through the second current source I2 and the second switch S2; on the other hand, when finding through comparison that the oscillating voltage has reached the low threshold value L, the third comparator Amp3 controls the second switch S2 to turn off, so that the capacitor C is charged through the first current source I1.

It can be seen from the configuration of the clock generation circuit 13022 that, the frequency of the clock signal CLK are proportional to the current of the first current source I1 that is controlled by the control voltage Vcon, so the frequency of the clock signal CLK is also proportional to a value of the load.

Furthermore, the circuit structure of the bias calculation circuit 13023 comprises a calculator U1, an amplification circuit U2 and an amplitude limiter circuit U3. A negative terminal of the calculator U1 is electrically connected to the output terminal of the error amplifier EA, and a positive terminal of the calculator U1 is configured to set the first threshold value Vth1, so that a voltage difference between the first threshold value Vth1 and the control voltage Vcon can be calculated by the calculator U1 to generate a differential voltage.

The amplification circuit U2 is electrically connected to the calculator U1, and is primarily configured to, depending on requirements of the practical design, amplify the differential voltage by a magnitude for use in the subsequent comparison operation. Herein, there is no limitation on the magnitude.

The amplitude limiter circuit U3 is electrically connected to the amplification circuit U2 to prevent appearance of a negative voltage. In other words, if the differential voltage calculated by the calculator U1 is a negative voltage, the amplitude limiter circuit U3 will limit the differential voltage to zero volt. In practical operation, when the control voltage Vcon is lower than the first threshold value Vth1, the differential voltage has a positive value and the amplitude limiter circuit U3 generates the bias voltage Vbias according to the amplified differential voltage, in which the bias voltage Vbias is inversely proportional to the value of the load. On the other hand, when the control voltage Vcon is greater than the first threshold value Vth1, the differential voltage has a negative value, in which the amplitude limiter circuit U3 will operate to limit the amplitude of the differential voltage to generate a zero voltage level.

As per the first comparator 1303 of the power factor correction controller 130, the first comparator 1303 has a positive input terminal thereof electrically connected to the sampling circuit 1300 to receive the input voltage Vin′ of a specific level, and has a negative input terminal thereof electrically connected to the amplitude limiter circuit U3 to receive the bias voltage Vbias. Therefore, the first comparator 1303 can compare the bias voltage Vbias with the input voltage Vin′ to generate a triggering signal T. In practical design, when the input voltage Vin′ is greater than the bias voltage Vbias, the first comparator 1303 outputs an enable signal (e.g., a logic high signal); on the other hand, when the input voltage Vin′ is less than or equal to the bias voltage Vbias, the first comparator 1303 outputs a disable signal (e.g., a logic low signal).

Finally, in practical applications, the drive unit 1304 may be, for example, designed as a PWM generator, which is electrically connected to the voltage regulation unit 1301, the signal generation circuit 1302 and the first comparator 1303 and is triggered by the triggering signal T. While it is operating, the drive unit 1304 outputs a drive signal Drive according to an actual value of the load to control the operating state and switching frequencies of the transistor Q in different specific modes.

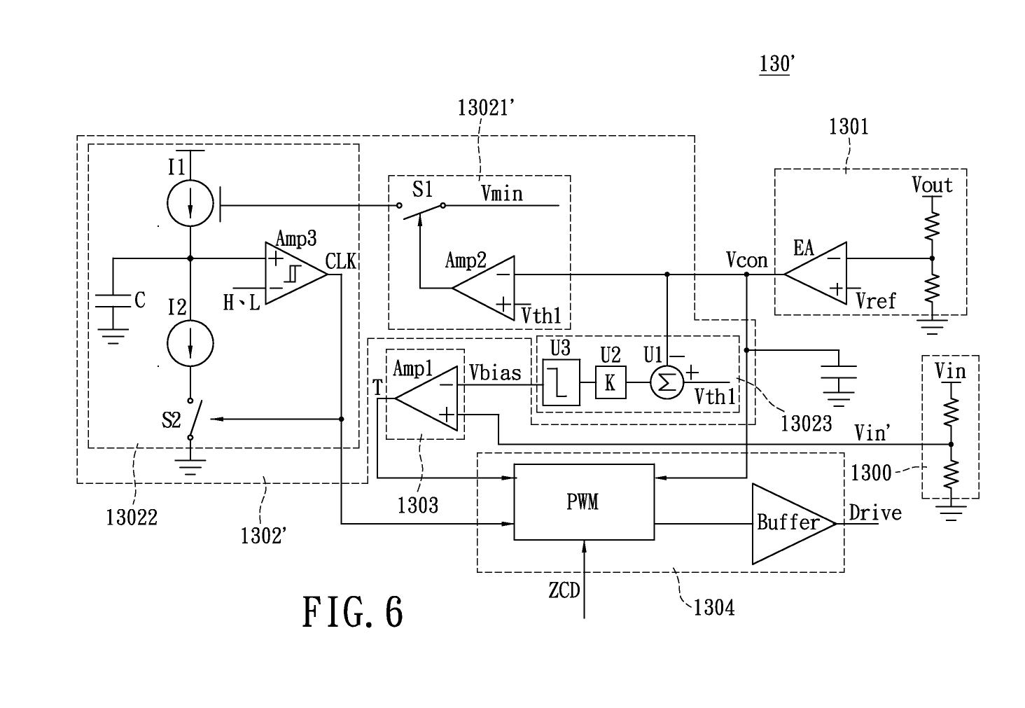

Referring to FIG. 5 together, a schematic view of the operation modes versus the load value and switching frequency of the power factor correction circuit according to the present invention is shown. With reference to this figure, controlling operations of the power factor correction circuit 13 with the aforesaid configuration of the power factor correction controller 130 will be described.

First, when a heavy load condition presents and the control voltage Vcon is greater than or equal to the second threshold value (Vconth2), the first switch S1 is turned off. Accordingly, the clock generation circuit 13022 generates a clock signal CLK according to operations of the first current source I1 and the second current source I2. In this case, the control voltage Vcon represents the conduction time of the transistor Q, and the heavier the load is, the greater the control voltage Vcon is. On the other hand, because now the control voltage Vcon is greater than the second threshold value Vth2, the bias calculation circuit 13023 generates a bias voltage Vbias having a zero value, which causes the input voltage Vin′ to be necessarily greater than the zero bias voltage Vbias. Thus, an enable signal is outputted by the first comparator 1303. Accordingly, the drive unit 1304 operates according to the enable signal and controls the transistor Q to operate in a critical conduction mode (CRM) according to the control voltage Vcon, the clock signal CLK and the zero-crossing detection signal ZCD. The zero-crossing detection signal ZCD is used to determine a time point at which the current flowing through the inductor L decreases to zero and is able to confirm a time point at which the transistor Q shall be turned on; this, as well as relevant operations in the critical conduction mode, will be readily understood by those of ordinary skill in the art, and thus will not be further described herein.

Next, as the load decreases, the switching frequency of the transistor Q increases gradually. When the circuit enters a light load status, i.e., when the control voltage Vcon is lower than the second threshold value Vth2, the first switch S1 is turned on and, accordingly, the clock generation circuit 13022 controls generation of the clock signal CLK according to the control voltage Vcon. Because the frequency of the clock signal CLK is proportional to the control voltage Vcon, the lower the control voltage Vcon (i.e., the lighter the load) is, the lower the frequency of the clock signal CLK will be. Additionally, it is assumed that now the control voltage Vcon is still greater than the first threshold value Vth1 (Vth1≦Vcon<Vth2), then the bias calculation circuit 13023 still generates a bias voltage Vbias having a zero value, causing the input voltage Vin′ to be necessarily greater than the zero bias voltage Vbias. Accordingly, the first comparator 1303 still outputs an enable signal. Therefore, the drive unit 1304 is enabled to operate according to the enable signal, and controls the transistor Q to operate in a discontinuous conduction mode (DCM) with a reduced switching frequency according to the control voltage Vcon, the clock signal CLK and the zero-crossing detection signal ZCD. Thus, as the load decreases (i.e., as the control voltage Vcon decreases), the switching frequency of the transistor Q also decreases accordingly to cause less switching power consumption, thereby improving the light load efficiency of the electric power converter 1.

When the load decreases continuously to render the control voltage Vcon less than the first threshold value Vth1 (Vcon<Vth1), the circuit enters a standby mode in this embodiment. At this point, the first switch S1 is still turned on and, under control of the control voltage Vcon, the clock generation circuit 13022 outputs a constant clock signal CLK of the lowest frequency. Additionally, in terms of the bias calculation circuit 13023, the bias voltage Vbias now becomes greater than zero. Accordingly, the first comparator 1303 must actually compare the bias voltage Vbias with the input voltage Vin′. When the input voltage Vin′ is greater than the bias voltage Vbias, the first comparator 1303 outputs an enable signal so that the drive unit 1304 is enabled to operate according to the enable signal and to control the switching frequency of the transistor Q according to the clock signal CLK. Otherwise, when the input voltage Vin′ is lower than the bias voltage Vbias, the first comparator 1303 outputs a disable signal so that the drive unit 1304 is disabled according to the disable signal. Therefore, when the load becomes lighter (i.e., the control voltage Vcon becomes smaller), the bias voltage Vbias will become greater and, consequently, the transistor Q will operate for a shorter time duration and only operate in a region corresponding to a relatively high input voltage Vin′. Consequently, the electric power consumption is further reduced, and the conversion efficiency is improved.

Therefore, according to variations of the actual load, the power factor correction controller 130 of the first embodiment controls the power factor correction circuit 13 to operate in the critical conduction mode, the discontinuous conduction mode and the standby mode.

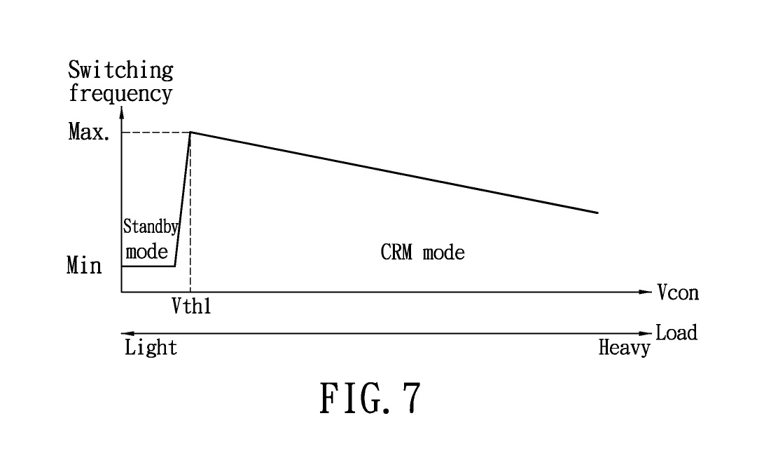

Referring next to FIG. 6, schematic circuit diagram of a second embodiment of the power factor correction controller according to the present invention is demonstrated. This embodiment differs from the first embodiment in that, the power factor correction controller 130′ of this embodiment is designed to control the power factor correction circuit 13 to operate in the critical conduction mode and the standby mode according to variations of the load.

The difference in circuit design lies in the switch circuit 13021′ of the signal generation circuit 1302′, with other portions being substantially the same. As shown in FIG. 6, the switch circuit 13021′ also includes a first switch S1 and a second comparator Amp2. However, one terminal of the first switch S1 is set to a reference voltage value Vmin; a positive input terminal of the second comparator Amp2 is set to the first threshold value Vth1, and a negative input terminal of the second comparator Amp2 is electrically connected to the output terminal of the error amplifier EA, so that the second comparator Amp2 can control the first switch S1 to be turned on or off according to a result of comparing the first threshold value Vth1 with the control voltage Vcon. Specifically, when the control voltage Vcon is greater than or equal to the first threshold value Vth1, the second comparator Amp2 controls the first switch S1 to be turned off; otherwise, when the control voltage Vcon is less than the first threshold value Vth1, the second comparator Amp2 controls the first switch S1 to be turned on.

For the clock generation circuit 13022, because the first current source I1 has the control terminal thereof electrically connected to the other terminal of the first switch S1, the current output can be regulated directly according to the reference voltage value Vmin when the first switch S1 is turned on. Thus, the clock generation circuit 13022 is allowed to generate the clock signal CLK according to the reference voltage value Vmin when the first switch S1 is turned on.

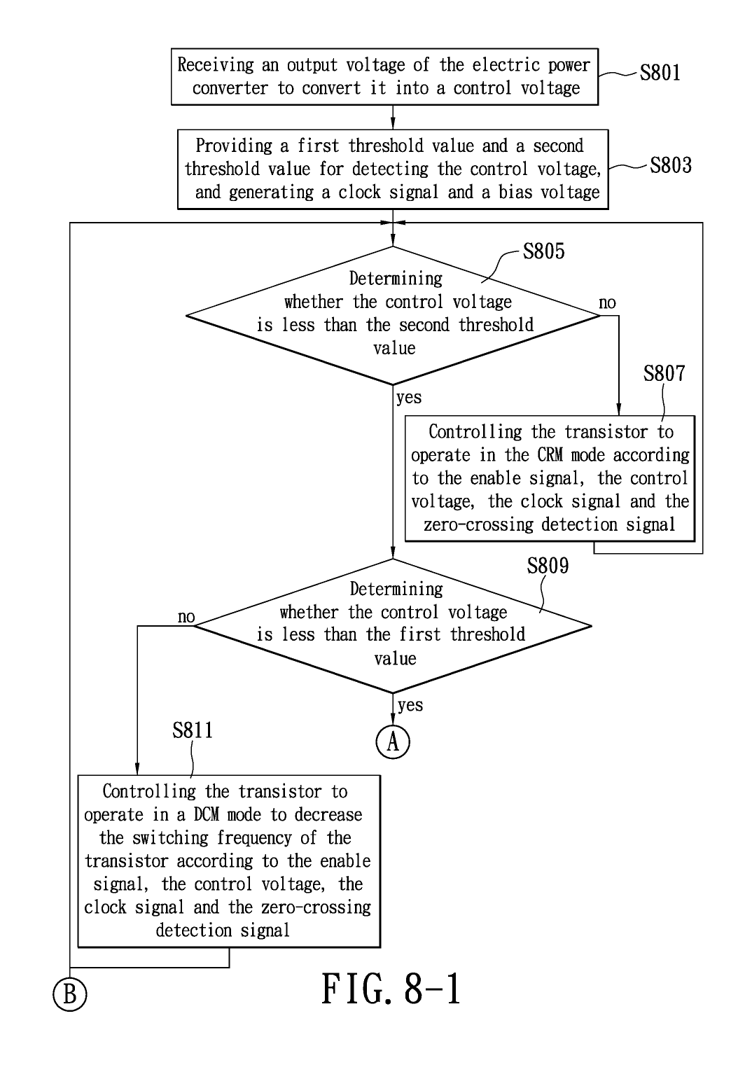

Referring to FIG. 7 together, a schematic view of the operation modes versus the load value and switching frequency of the power factor correction circuit according to the second embodiment of the present invention is demonstrated. With reference to this figure, controlling operations of the power factor correction circuit 13 with the aforesaid schematic of the power factor correction controller 130′ will be described.

First, when a heavy load condition presents and the control voltage Vcon is greater than or equal to the first threshold value (Vcon≧Vth1), the first switch S1 is turned off. In this state, operations are substantially the same as those in the state of the first embodiment when the control voltage Vcon is greater than or equal to the second threshold value Vth2. Accordingly, the drive unit 1304 is enabled to operate according to the enable signal and controls the transistor Q to operate in the critical conduction mode (CRM) according to the control voltage Vcon, the clock signal CLK and the zero-crossing detection signal ZCD.

Then, as the load decreases, the switching frequency of the transistor Q gradually increases to the highest frequency. When the load decreases continuously until the control voltage Vcon is lower than the first threshold value Vth1 (Vcon<Vth1), the circuit will enter the standby mode as in the first embodiment. In this case, the first switch S1 is turned on to allow the clock generation circuit 13022 to, under control of the reference voltage value Vmin, output a constant clock signal CLK of the lowest frequency. Thus, the drive unit 1304 is enabled to operate according to the enable signal and to control the switching frequency of the transistor Q according to the clock signal CLK.

Next, a controlling operation process of the power factor correction controller of the present invention will be further described. Here, the description will be made with reference to only the power factor correction controller 130 of the first embodiment that is used to control operations in the critical conduction mode, the discontinuous conduction mode and the standby mode; however, it is believed that those of ordinary skill in the art may make slight modifications on this operation process to make it applicable to the power factor correction controller 130′ of the second embodiment (which controls operations in the critical conduction mode and the standby mode), and this will not be further described herein.

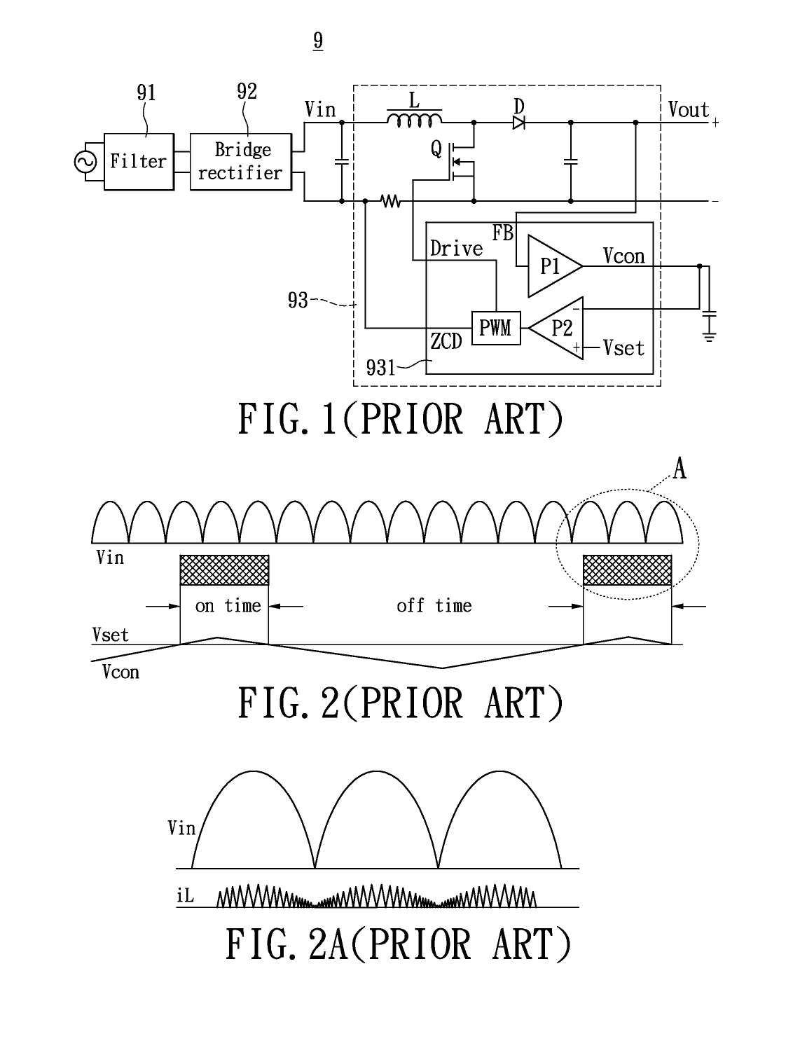

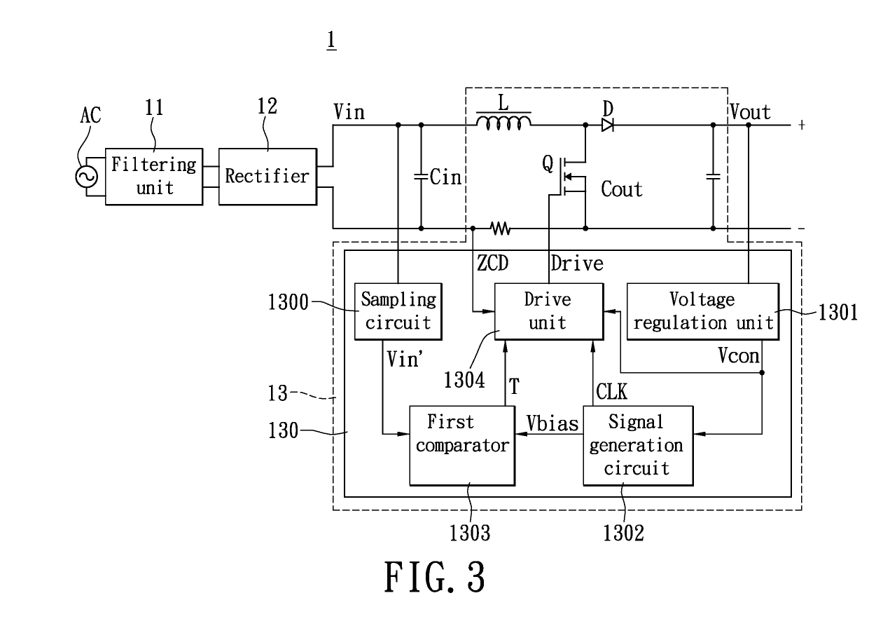

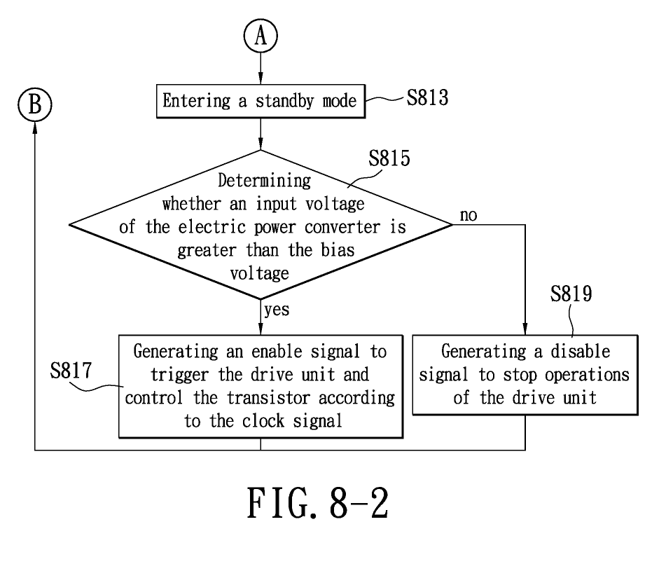

Referring to FIG. 8-1 and FIG. 8-2, a flowchart of an embodiment of a controlling method for the power factor correction controller of the present invention is demonstrated. As shown, the controlling method of this embodiment comprises the following steps. First, an output voltage Vout of the electric power converter 1 is received and converted into a control voltage Vcon (S801). Then, a first threshold value Vth1 and a second threshold value Vth2 are provided to detect the control voltage Vcon to generate a clock signal CLK and a bias voltage Vbias (S803). Here, the second threshold value Vth2 is greater than the first threshold value Vth1.

Next, it is determined whether the control voltage Vcon is less than the second threshold value Vth2 (S805). If the determination result of step (S805) is “no”, it means that the control voltage Vcon is greater than or equal to the second threshold value Vth2. In this case, the bias voltage Vbias is limited to a zero voltage, so through a comparison between the bias voltage and the input voltage Vin′, an enable signal will necessarily be generated without affecting operation of the drive unit 1304. The drive unit 1304 is enabled to operate according to the enable signal, and to control the transistor Q to operate in the critical conduction mode according to the control voltage Vcon, the clock signal CLK and the zero-crossing detection signal ZCD (S807).

If the determination result of step (S805) is “yes”, then it is further determined whether the control voltage Vcon is less than the first threshold value Vth1 (S809). If the determination result of step (S809) is “no”, it means that the control voltage Vcon is less than the second threshold value Vth2 but greater than or equal to the first threshold value Vth1. In this case, the bias voltage Vbias is still limited to a zero voltage, so through a comparison between the bias voltage Vbias and the input voltage Vin′, an enable signal will still necessarily be generated without affecting operation of the drive unit 1304. Still, the drive unit 1304 is enabled to operate according to the enable signal, and to control the transistor Q to operate in the discontinuous conduction mode according to the control voltage Vcon, the clock signal CLK and the zero-crossing detection signal ZCD, and the switching frequency of the transistor Q decreases as the control voltage Vcon decreases (S811).

If the determination result of step (S809) is “yes”, it means that the control voltage Vcon is less than the first threshold value Vth1. In this case, the circuit enters a standby mode (S813). In the standby mode, because the bias voltage Vbias is greater than the zero voltage, it must be actually determined whether the current input voltage Vin′ is greater than the bias voltage Vbias (S815). If the determination result of step (S815) is “yes”, then an enable signal is generated to enable the operation of the drive unit 1304 so that the drive unit 1304 controls the switching frequency of the transistor Q according to the clock signal CLK (S817). Otherwise, if the determination result of step (S815) is “no”, then a disable signal is generated to stop operation of the drive unit 1304 (S819).

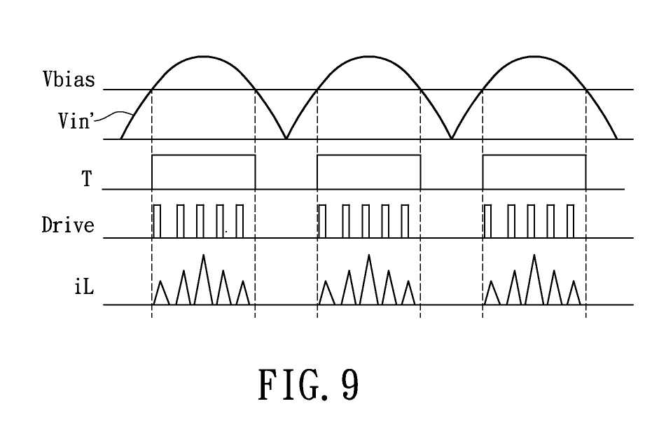

Finally, referring further to FIG. 9, a waveform diagram of an embodiment of the power factor correction circuit according to the present invention in a standby mode is presented. As shown, in regions where the input voltage Vin′ is greater than the bias voltage Vbias, the triggering signal T is an enable signal (a high level signal), in which case the transistor Q is controlled by the drive signal Drive, which is outputted by the drive unit 1304, to operate at the lowest switching frequency; in contrast, in regions where the input voltage vin′ is less than the bias voltage Vbias, the trigger signal T is a disable signal (a low level signal), in which case the drive unit 1304 is disabled and, accordingly, the transistor Q is turned off. Additionally, when the load is lighter, the control voltage Vcon becomes lower and the bias voltage Vbias becomes higher, and accordingly, the operation duration of the transistor Q becomes shorter. Thus, the ultimate objective for reducing electric power consumption is accomplished.

In summary, through design of the power factor correction controller, the present invention is able to control the power factor correction circuit to operate in different modes depending on an actual value of the load. Especially under a very light load or a no-load condition, a standby mode is designed to allow the power factor correction circuit to operate only when the input voltage has a high instantaneous level and not operate near the zero-crossing point. Consequently, the energy transmission efficiency of the electric power converter is improved, and the electric power consumption under a light load and a no-load condition is reduced. Meanwhile, this can ensure smaller variations of the output voltage, which is favorable for optimization of the light load efficiency associated with the DC/DC converter of the next stage.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A power factor correction controller, being adapted for a power factor correction circuit in a critical conduction mode of an electric power converter, comprising:
a voltage regulation unit, being configured to receive an output voltage of the electric power converter to generate a control voltage;
a signal generation circuit, being configured to generate a clock signal and, by use of a predetermined first threshold value, to detect the control voltage to generate an bias voltage according to a level of the control voltage;
a first comparator, being configured to compare the bias voltage with an input voltage of the electric power converter to generate a triggering signal; and
a drive unit, being electrically connected to the voltage regulation unit, the signal generation circuit and the first comparator, and being configured to control a transistor of the power factor correction circuit;
Whereby as the control voltage is lower than the first threshold value, the drive unit controls the transistor to operate in a standby mode according to the triggering signal and the clock signal.

2. The power factor correction controller according to claim 1, wherein the control voltage and a frequency of the clock signal are proportional to a value of a load connected to the electric power converter.

3. The power factor correction controller according to claim 2, wherein as the first comparator determines through comparison that the input voltage is greater than the bias voltage, the first comparator generates an enable signal so that the drive unit operates according to the enable signal, and when the first comparator determines through comparison that the input voltage is less than or equal to the bias voltage, the first comparator generates a disable signal so that the drive unit is disabled according to the disable signal.

4. The power factor correction controller according to claim 2, wherein the signal generation circuit further includes a bias calculation circuit, comprising:
a calculator, wherein a negative terminal of the calculator is electrically connected to the voltage regulation unit to receive the control voltage, and a positive terminal of the calculator is set to the first threshold value so that a difference between the first threshold value and the control voltage is calculated by the calculator to generate a differential voltage;
an amplification circuit, being electrically connected to the calculator, and being configured to amplify the differential voltage by a magnitude; and
an amplitude limiter circuit, being electrically connected to the amplification circuit and a negative input terminal of the first comparator;
wherein as the control voltage is less than the first threshold value, the amplitude limiter circuit generates the bias voltage to the first comparator according to the amplified differential voltage; and as the control voltage is greater than the first threshold value, the amplitude limiter circuit limits an amplitude to generate a zero voltage;
whereby as the control voltage is less than the first threshold value, the bias voltage is inversely proportional to the value of the load.

5. The power factor correction controller according to claim 4, further comprising:
a sampling circuit, being electrically connected to a positive input terminal of the first comparator and configured to receive the input voltage and further regulate the input voltage to have a specific level to be outputted to the first comparator.

6. The power factor correction controller according to claim 2, wherein the signal generation circuit generates the clock signal according to a predetermined reference voltage value.

7. The power factor correction controller according to claim 6, wherein when the control voltage is greater than or equal to the first threshold value, the drive unit controls the transistor to operate in the critical conduction mode according to the triggering signal, the control voltage, the clock signal and a zero-crossing detection signal.

8. The power factor correction controller according to claim 7, wherein the signal generation circuit further includes a switch circuit, comprising:
a first switch, wherein one terminal of the first switch is set to the reference voltage value; and
a second comparator, wherein a positive input terminal of the second comparator is set to the first threshold value, a negative input terminal of the second comparator is electrically connected to the voltage regulation unit, and the second comparator is configured to compare the first threshold value with the control voltage so as to control the first switch to be turned on or turned off;
whereby as the control voltage is greater than or equal to the first threshold value, the second comparator controls the first switch to be turned off, and as the control voltage is less than the first threshold value, the second comparator controls the first switch to be turned on.

9. The power factor correction controller according to claim 8, wherein the signal generation circuit further includes a clock generation circuit, comprising:
a first current source, being a controllable current source, wherein a control terminal of the first current source is electrically connected to the other terminal of the first switch so as to regulate a current output according to the reference voltage value when the first switch is turned on;
a second current source, being connected in series with the first current source, and a current of the second current source is twice as that of the first current source;
a second switch, having one terminal electrically connected to the second current source and having the other terminal connected to the ground;
a capacitor, having one terminal electrically connected to a connecting junction of the first current source and the second current source and having the other terminal connected to the ground, so that an oscillating voltage is generated through the capacitor; and
a third comparator, being configured to generate the clock signal according to the oscillation voltage, a positive input terminal of the third comparator being electrically connected to a connecting junction of the first current source, the second current source and the capacitor, and a negative input terminal of the third comparator being set to a high threshold value and a low threshold value;
wherein as the oscillation voltage reaches the high threshold value, the third comparator controls the second switch to be turned on, so that the capacitor is discharged through the second current source and the second switch, and as the oscillation voltage reaches the low threshold value, the third comparator controls the second switch to be turned off, so that the capacitor is charged through the first current source;
wherein the current of the first current source, the oscillating voltage, and the frequency of the clock signal are proportional to each other.

10. The power factor correction controller according to claim 2, wherein the signal generation circuit further presets a second threshold value which is greater than the first threshold value, and further detects the control voltage by use of the second threshold value so as to generate the clock signal according to a level of the control voltage.

11. The power factor correction controller according to claim 10, wherein when the control voltage is less than the second threshold value but greater than or equal to the first threshold value, the drive unit controls the transistor to decrease a switching frequency of the transistor according to the triggering signal, the control voltage, the clock signal and a zero-crossing detection signal; and
when the control voltage is greater than or equal to the second threshold value, the drive unit controls the transistor to operate in the critical conduction mode according to the triggering signal, the control voltage, the clock signal and the zero-crossing detection signal.

12. The power factor correction controller according to claim 10, wherein the signal generation circuit further includes a switch circuit, comprising:
a first switch, having one terminal electrically connected to the voltage regulation unit; and
a second comparator, wherein a positive input terminal of the second comparator is set to the second threshold value, and a negative input terminal of the second comparator is electrically connected to the voltage regulation unit; the second comparator is configured to compare the second threshold value with the control voltage to control the first switch to be turned on or turned off;
whereby as the control voltage is greater than or equal to the second threshold value, the second comparator controls the first switch to be turned off, and as the control voltage is less than the second threshold value, the second comparator controls the first switch to be turned on.

13. The power factor correction controller according to claim 12, wherein the signal generation circuit further includes a clock generation circuit, comprising:
a first current source, being a controllable current source, wherein a control terminal of the first current source is electrically connected to the other terminal of the first switch so as to regulate a current output in proportion to the level of the control voltage when the first switch is turned on;
a second current source, being connected in series with the first current source, and a current of the second current source is twice as that of the first current source;
a second switch, having one terminal electrically connected to the second current source and having the other terminal connected to the ground;
a capacitor, having one terminal electrically connected to a connecting junction of the first current source and the second current source and having the other terminal connected to the ground, so that an oscillating voltage is generated through the capacitor; and
a third comparator, being configured to generate the clock signal according to the oscillation voltage, a positive input terminal of the third comparator being electrically connected to the a connecting junction of the first current source, the second current source and the capacitor, and a negative input terminal of the third comparator being set to a high threshold value and a low threshold value;
wherein as the oscillation voltage reaches the high threshold value, the third comparator controls the second switch to be turned on, so that the capacitor is discharged through the second current source and the second switch, and as the oscillation voltage reaches the low threshold value, the third comparator controls the second switch to be turned off, so that the capacitor is charged through the first current source;
wherein the current of the first current source, the oscillating voltage and the frequency of the clock signal are proportional to each other.

14. A control method for a power factor correction controller, wherein the power factor correction controller is adapted for a power factor correction circuit in a critical conduction mode of an electric power converter, the control method comprising the following steps of:
converting an output voltage of the electric power converter into a control voltage;
generating a clock signal, and utilizing a first threshold value to detect the control voltage to generate a bias voltage according to a level of the control voltage;
comparing the bias voltage with an input voltage of the electric power converter to generate a triggering signal; and
providing a drive unit for controlling a transistor of the power factor correction circuit, and when the control voltage is less than the first threshold value, the drive unit controls the transistor to operate in a standby mode according to the triggering signal and the clock signal.

15. The control method for a power factor correction controller according to claim 14, wherein the control voltage is proportional to a value of a load connected to the electric power converter, and a frequency of the clock signal is also proportional to the value of the load.

16. The control method for a power factor correction controller according to claim 15, wherein if the input voltage is greater than the bias voltage, an enable signal is generated to trigger operations of the drive unit; and if the input voltage is less than or equal to the bias voltage, a disable signal is generated to stop operations of the drive unit.

17. The control method for a power factor correction controller according to claim 15, wherein the clock signal is generated according to a predetermined reference voltage value, and when the control voltage is greater than or equal to the first threshold value, the drive unit controls the transistor to operate in the critical conduction mode according to the triggering signal, the control voltage, the clock signal and a zero-crossing detection signal.

18. The control method for a power factor correction controller according to claim 15, further comprising:
utilizing a second threshold value to further detect the control voltage and generating the clock signal according to the level of the control voltage, wherein the second threshold value is greater than the first threshold value.

19. The control method for a power factor correction controller according to claim 18, wherein when the control voltage is less than the second threshold value but greater than or equal to the first threshold value, the drive unit controls the transistor to decrease a switching frequency of the transistor according to the triggering signal, the control voltage, the clock signal and a zero-crossing detection signal; and
when the control voltage is greater than or equal to the second threshold value, the drive unit controls the transistor to operate in the critical conduction mode according to the triggering signal, the control voltage, the clock signal and the zero-crossing detection signal.

20. An electric power converter having a power factor correction controller according to claim 1.
